(19) United States
(12) Patent Application Publication
(10) Pub. No.: US 2020/0175510 A1
(43) Pub. Date: Jun. 4, 2020

(54) METHOD AND SYSTEM FOR FACILITATING FACIAL-RECOGNITION-BASED PAYMENT SYSTEM WITH MULTIPLE VIEWING ANGLES AND REDUCED MISPAYMENT RISK

(71) Applicant: Alibaba Group Holding Limited, George Town (KY)

(72) Inventor: Tao Fang, Hangzhou (CN)

(73) Assignee: Alibaba Group Holding Limited, George Town (KY)

(21) Appl. No.: 16/600,318

(22) Filed: Oct. 11, 2019

(30) Foreign Application Priority Data
Nov. 30, 2018 (CN) 201811459514.8

(51) Int. Cl. G06Q 20/38; G06K 9/00

(52) U.S. Cl. CPC G06Q 20/3821; G06K 9/00335; G06K 9/00288

(57) ABSTRACT

One embodiment described herein provides a system for facilitating processing payment based on facial recognition. During operation, the system obtains, from a first camera, visual information associated with a payment scene comprising bodies of one or more customers. In response to receiving a payment-initialization command, the system obtains, from a second camera, an image comprising faces of the one or more customers. The system identifies, based on the visual information associated with the payment scene, a body that is performing a movement to enter the payment-initialization command, and identifies a face in the image obtained from the second camera based on user-identification information associated with the identified body. The system then extracts facial information from the identified face, thereby facilitating a transaction of the payment based on the extracted facial information.

### RELATED APPLICATION

Under 35 U.S.C. § 119, this application claims the benefit and right of priority of Chinese Patent Application No. 201811459514.8, filed 30 Nov. 2018.

### BACKGROUND

### Field

This disclosure is generally related to a payment system based on facial recognition. More specifically, this disclosure is related to a facial-recognition-based payment system that can reduce the risk of misidentifying a paying customer from an image containing multiple faces.

### Related Art

Facial recognition technologies have been developed rapidly and found many applications in recent years. A facial recognition system can identify or verify a person by scanning the person's face. Such technologies have been used as access control in security systems. For example, a user can gain access to a mobile phone by allowing the mobile phone to capture an image of his face. Facial recognition systems have been compared to other biometric systems, such as fingerprint and iris recognition systems. Compared to fingerprint recognition and iris recognition, facial recognition has the advantage of being contactless and non-invasive.

In addition to access control, facial recognition technologies have found applications in areas like policing and national security. Moreover, facial recognition technologies can also be used in financial settings. More particularly, a customer of services or goods may render a payment by allowing images of his face to be captured or his face to be scanned. This payment method is often referred to as paying-with-a-face, in contrast with conventional payment methods of paying-with-a-card or paying-with-cash. However, in many retail scenarios (e.g., in a supermarket), the image-capturing device may capture an image containing multiple faces and a mispayment may occur if a wrong face is identified as the face of the paying customer.

### SUMMARY

One embodiment described herein provides a system for facilitating processing a payment based on facial recognition. During operation, the system can obtain, from a first camera, visual information associated with a payment scene which can include one or more customers. In response to receiving a payment-initialization command, the system can obtain, from a second camera, an image including faces of the one or more customers. The system can identify, based on the visual information associated with the payment scene, a body performing a movement while entering the payment-initialization command, and can identify a face in the image obtained from the second camera based on user-identification information associated with the identified body. The system can then extract facial information from the identified face, thereby facilitating a transaction of the payment based on the extracted facial information.

In a variation on this embodiment, the visual information associated with the payment scene can include a video or a still image.

In a variation on this embodiment, identifying the body performing the movement can include receiving timing information associated with the payment-initialization command and analyzing the visual information based on the received timing information.

In a further variation, analyzing the visual information can include one or more of: recognizing a posture of the body, recognizing a movement of a portion of the body, and recognizing a position of the body or the portion of the body.

In a variation on this embodiment, the user-identification information can include one or more of: body posture information, position information, partial facial information, and apparel information.

In a variation on this embodiment, identifying the face can include: extracting, from each face included in the image, user-identification information associated with each face and comparing the user-identification information associated with each face to the user-identification information associated with the identified body.

In a further variation, in response to failing to find a match or finding multiple matches between the user-identification information associated with each face and the user-identification information associated with the identified body, the system can display an error message.

In a variation on this embodiment, the system can identify a customer based on the extracted facial information, identify an account corresponding to the identified customer, and complete the transaction using the identified account.

In a variation on this embodiment, the payment-initialization command can include one or more of: a tapping of a predetermined icon on a touchscreen display, a keystroke on a keyboard, and a press of a physical button.

In a variation on this embodiment, a field of view (FOV) of the first camera can be greater than a FOV of the second camera.

### BRIEF DESCRIPTION OF THE FIGURES

FIG. 1A illustrates an exemplary placement of multiple cameras, according to one embodiment.

FIG. 1B illustrates an exemplary placement of multiple cameras, according to one embodiment.

FIG. 2 illustrates a block diagram of an exemplary facial-recognition-based payment system, according to one embodiment.

FIG. 3 presents a flowchart illustrating exemplary operations of the novel payment system having multiple viewing angles, according to one embodiment.

FIGS. 4A-4C show various camera placement schemes, according to one embodiment.

FIG. 5 illustrates an exemplary operation scenario of the novel payment system, according to one embodiment.

FIG. 6 illustrates an exemplary operation scenario of the novel payment system, according to one embodiment.

FIG. 7 illustrates an exemplary operation scenario of the novel payment system, according to one embodiment.

FIG. 8 illustrates an exemplary network environment for implementing the disclosed technology, in accordance with some embodiments described herein.

FIG. 9 conceptually illustrates an electronic system with which the subject technology is implemented, in accordance with some embodiments described herein.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Overview

In this disclosure, a method and system is provided for a payment system that uses the facial recognition technology to process payment. More specifically, the payment system can include a multi-angle image-capturing system, which can include multiple cameras. One camera can be used to monitor body movements of one or more customers and determine which customer is the one entering a command on a POS (point of sale) terminal or a face-payment user interface. Such a customer is the one intending to make the payment for services or goods. Another camera can be used to collect facial information of the one or more customers. Once the system determines which customer is the paying customer, the system can extract and send the corresponding facial information of the paying customer to a remote face-payment server, which uses a facial recognition technology to identify the paying customer and an account associated with the paying customer. The payment system can then complete the payment transaction using the identified account. If the system cannot decide which customer is paying or if multiple customers are entering commands on the face-payment user interface, the system may abandon the payment process and request the paying customer to re-enter the command.

In this disclosure, the terms “user” and “customer” can sometimes be interchangeable and are typically used to refer to a person using the system to make a payment.

A Novel Payment System

Although facial recognition technologies have been mature enough for certain commercial usages (e.g., the Face ID technology used by Apple Inc.), their usage in financial domains is still in the early development stage. In current approaches, at the point of sale (POS), a customer can render a payment by allowing a camera to capture an image of his face or a face scanner to scan his face. Facial information of the customer can be extracted from the captured image or the face scan, and the payment system can use the facial information to identify the customer and the customer's account. Once the customer's account is identified, the appropriate amount of funds can be transferred from the customer's account to the vendor's account. Such a payment method is often referred to as paying-with-a-face, as opposed to the conventional payment method of paying-with-a-card or paying-with-cash. A payment system that enables the paying-with-a-face payment method can be referred to as a paying-with-a-face payment system or simply face-payment system. A paying-with-a-face payment system can provide a simple, contactless way for customers to render payment. A customer does not need to swipe a card or submit cash (both payment methods require the customer to carry additional items and reach and/or search for a pocket or wallet), thus significantly enhancing the customer experience.

However, there exist risks in the current paying-with-a-face payment system. More particularly, multiple faces may co-exist in an image captured by the payment system, making it difficult for the payment system to determine which face belongs to the customer rendering the payment. There is the possibility that the payment system may mistake a bystander as the paying customer and accidentally transfer funds from the bystander's account instead of from the account of the paying customer. To mitigate such a risk, some payment systems require that, when paying with his face, a customer needs to display a special pose (e.g., the thumbs up or “OK” gesture) in order to explicitly indicate his desire to make a payment. However, such an approach adds an additional burden to the customer and can compromise the customer experience. Moreover, if there happens to be more than one user displaying the required pose, the system may still misidentify the paying customer.

To mitigate the risk of mispayment, embodiments of the present invention provide a novel paying-with-a-face payment system that can detect the real paying customer. More specifically, this novel payment system can include multiple cameras that can capture images of a scene containing the paying customer from different angles. One camera can be a webcam that continuously records and streams videos of the payment scene at the POS. The webcam (referred to as a body camera) can be set up so as to capture body movements of customers (including the paying customer and possible bystanders) at the payment scene, especially the part of a body (e.g., an arm or a hand) that makes movements to initialize or confirm the payment. Such images can be referred to as body images and can be used to identify, from a plurality of individuals, the individual making the payment. Another camera (referred to as a face camera) can be set up so as to capture close up images of faces of customers in the payment scene.

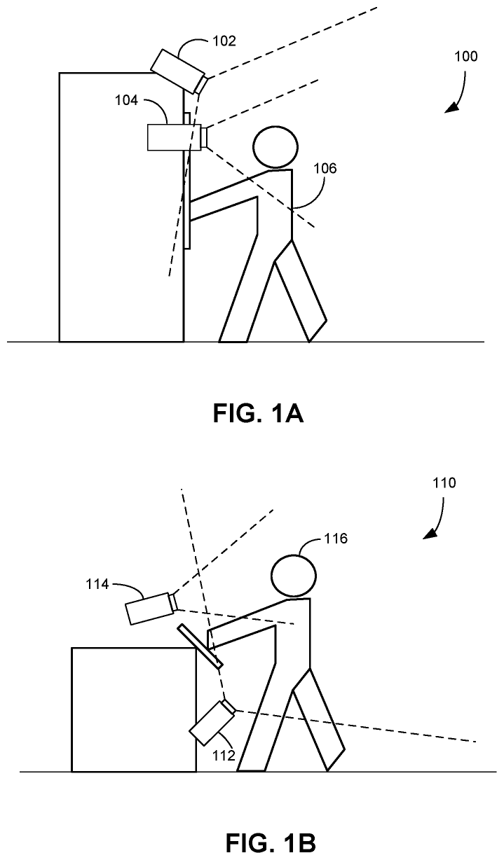

FIG. 1A illustrates an exemplary placement of multiple cameras, according to one embodiment. Image-capturing system 100 can include a body camera 102 and a face camera 104. Body camera 102 can be used to capture full shots of a payment scene that includes one or more individuals. To do so, the field of view (FOV) of body camera 102 needs to be wide enough to substantially include the entire human body, as shown by the corresponding dashed lines in FIG. 1A. More specifically, in FIG. 1A, body camera 102 can be placed at a location that is substantially above the head of a person of average height and can point slightly downward such that the FOV of camera 102 can include the entire body of user 106. Actions performed by any body part (e.g., an arm or a leg) of user 106 can be recorded by body camera 102. On the other hand, face camera 104 can be placed at a location that is substantially at the eye level of a person of average height and can point horizontally, as shown in FIG. 1A. The FOV of face camera 104 (as shown by the corresponding dashed lines in FIG. 1A) can be significantly smaller than that of body camera 102. More specifically, face camera 104 can be configured so as to capture close up images of the face of user 106 when user 106 is entering a user command to start the payment process. Such close up images can be used to extract facial information of user 106. In some embodiments, the position and/or orientation (e.g., left and right, up and down, forward and back, tiling angles, etc.) of body camera 102 and face camera 104 can be adjusted automatically or manually, thereby allowing body camera 102 and face camera 104 to best capture the body movements and faces of the customers. Moreover, although only two cameras are shown in FIG. 1A, in practice, image-capturing system 100 can include more than two cameras capable of capturing the payment scene from more than two viewing angles.

A paying-with-a-face payment system typically requires a customer to manually initialize or start up the payment process by inputting a user command. More specifically, the customer can tap an icon on a touchscreen display or press a key on a keyboard. The touchscreen display or keyboard can be part of a POS terminal or a separate device coupled to the POS terminal. By identifying an individual customer performing such an action, the system can identify the paying customer from a plurality of customers at the scene. More specifically, the payment system can record the time instant when the customer inputs the command and extract a video clip or one or more images from the video recorded by a webcam based on the time instant. Because such a video clip or images are captured at the instant the customer is entering the command, they can capture the body movements of the customer while entering the command. The system can then apply an image-analyzing technique to identify a body making such movements. For example, using the image-analyzing technique, the system can recognize one or more human bodies or body parts (e.g., hands or arms) from an image, and can identify a body or body part performing that particular movement (e.g., tapping the touchscreen or pressing the keyboard).

Upon receiving the customer's manual command, a face camera can be triggered to capture one or more images. The face camera can be up so the captured images include the customer's face to allow the system to extract facial information of the customer. In the event that a captured image includes multiple faces, the system can correlate the body or body part identified in images captured by the body camera with a face in the image captured by the face camera. This way, the system can determine that the face belongs to the paying customer and can then use facial information extracted from such a face to identify the paying customer and an account associated with the paying customer.

To correlate the identified body or body part in one image with a face in another image, the system can first find, in the image captured by the body camera, a face or a part of a face that is connected to the identified body or body part. For example, using an image-analysis technique (e.g., a machine-learning technique), the system can identify the silhouettes of a number of human bodies in an image or video clip captured by the body camera. The identified silhouette of a particular body may include a partial face that can be linked to the full face in the image captured by the face camera. Moreover, certain apparel information (e.g., the color and/or pattern of a shirt) can also be used to link a face to an identified body, because both cameras may capture the apparel information. For example, a person wearing a red shirt can be captured by both the body camera and the face camera. In images captured by the body camera, the entire red shirt may be shown, whereas in images captured by the face camera, only a portion of the red shirt (e.g., a collar) may be shown. The red shirt shown in an image captured by the body camera can be correlated to the portion of the red shirt shown in an image captured by the face camera. If the system detects that the person wearing the red shirt is performing the payment-initializing action, the system can then determine that the face connected to the red collar shown in the image captured by the face camera is the face of the paying customer. In addition to apparel information, skin tones and body posture can also be used to correlate a body in one image (e.g., the full shot of the payment scene) to a face in the other image (e.g., the close up shot of a customer's face). For example, consistency in skin tone and/or body posture can be used to determine that a body shown in the full shot can be linked to a face shown in the close up shot.

In addition to the placement scheme shown in FIG. 1A, the cameras can be placed at different locations, as long as one camera can capture body movements and/or postures of customer(s) and another camera can capture face images of the customer(s). FIG. 1B illustrates an exemplary placement of multiple cameras, according to one embodiment. In FIG. 1B, image-capturing system 110 can include a body camera 112 and a face camera 114. Body camera 112 can be placed at a location that is below the upper body of a customer 116 of an average height and can be pointed slightly upward. This way, the FOV of body camera 112 can include at least the upper body of user 116 such that any arm movement of user 116 can be recorded by body camera 112. On the other hand, face camera 114 can be placed slightly below the head of customer 116 and point slightly upward to capture close up shots of the face of user 116.

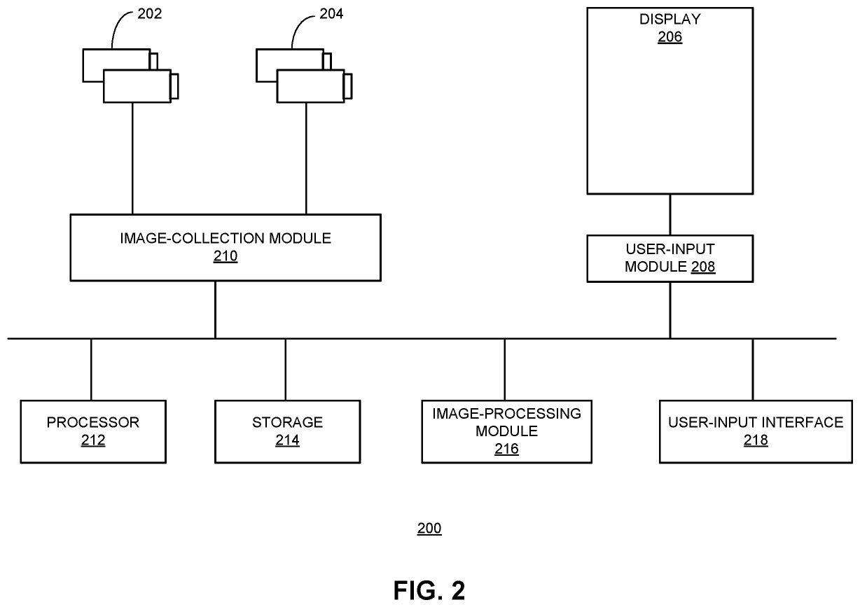

FIG. 2 illustrates a block diagram of an exemplary facial-recognition-based payment system, according to one embodiment. Payment system 200 can include one or more body cameras (e.g., a body camera 202), one or more face cameras (e.g., a face camera 204), and a display 206.

Body camera 202 can be similar to body camera 102 or 112 shown in FIG. 1A or 1B, respectively. More specifically, body camera 202 can be responsible for continuously recording the payment scene (e.g., at a location close to the POS terminal) where the customers are making payments for services or goods. In some embodiments, body camera 202 can take full shots of the payment scene. The location and viewing angle of body camera 202 can be carefully designed such that a substantial portion of the body (e.g., the body part that interacts with a device that allows the customer to initialize the payment process) of a paying customer can be captured. This way, the particular movement performed by the paying customer (e.g., the movement of extending an arm to click an icon on a touchscreen display or press a key on a keyboard) can be captured by body camera 202. In some embodiments, multiple body cameras can be placed at different locations to ensure that, wherever the customer is standing and however the customer is initializing the payment process, at least one body camera can capture the customer's body movements for initializing the payment process.

Face camera 204 can be responsible for capturing close up images of the customers' faces. The location and orientation of face camera 204 can be carefully designed to ensure that a substantially full face of the paying customer can be captured to allow the system to extract detailed facial information from the captured images.

Display 206 can display various information associated with the transaction, such as the amount due, the identified customer account, the confirmation of the payment, and one or more error messages. In some embodiments, display 206 can include a touchscreen display that can display a number of icons to allow the user to input a user command by tapping one of the icons. For example, display 206 can display a number of payment option icons and a customer can tap an icon to select the paying-with-a-face payment option. Alternatively, display 206 can be a regular, non-touchscreen display. In addition to display 206, payment system 200 can also include a user-input module 208 (which can include a keyboard, one or more physical buttons, or a pointing device) to allow the customer to enter the payment-initialization command. User-input module 208 (e.g., a keyboard or a pointing device) can be placed near display 206 such that movements of the customer for entering commands via user-input module 208 can be similarly captured by the body camera(s).

In addition to components that directly interface with customers (e.g., the cameras and the display), payment system 200 can additionally include various processing and storage modules, such as an image-collection module 210, a processor 212, a storage device 214, an image-processing module 216, and a user-input interface 218.

Image-collection module 210 can be responsible for collecting images from the face and body cameras that pertain to the payment-processing operation. For example, the body cameras are responsible for continuously monitoring and recording the payment scene, and not all images are related to the paying customer. Instead of sending all images captured by the cameras to image-processing module 216 for processing and analyzing, image-collection module 210 extracts useful images from the body cameras and face cameras. For example, image-collection module 210 can receive, from user-input module 208, timing information of the user input (e.g., a timestamp). Such timing information can be used by image-collection module 210 to collect images from the body cameras and the face cameras. Note that a face camera can be configured to capture face images in response to the system receiving a user command for initializing the payment process. Hence, an image captured by a face camera at a particular time instant is most likely to contain the customer making a payment at this particular time instant. Moreover, images or a video clip captured by a body camera at this particular time instant are most likely to include the body movements of the customer performing the payment-initializing action. Accordingly, image-collection module 210 can use such timing information to extract a video clip or a number of images from the video streamed from the body camera(s) and correlate such video clip or images to images captured by the face camera(s). In some embodiments, if a customer enters a user command at time t, image-collection module 210 can extract a video clip extending in the time domain from t−Δt to t+Δt, where Δt can be a predetermined time interval and can range from 0 to 5 s. Moreover, image-collection module 210 can obtain images captured by face camera(s) during the time duration from t to t+Δt. Image-collection module 210 can then correlate the video clip and images to the current payment process (i.e., the payment process triggered by the user command at time t). Accordingly, the system can use visual information (e.g., body movement information and facial information) extracted from the video clip and images to identify the paying customer.

Processor 212 can execute instructions stored in storage device 214 to perform the various operations needed for completing the payment process based on facial recognition.

Image-processing module 216 can be responsible for processing the images collected by image-collection module 210. For example, image-processing module 216 can analyze (e.g., using a machine-learning technique) the video clip or images captured by the body cameras to identify a customer (more particularly a body of the customer) who is performing the action of initializing the payment process. More specifically, by analyzing the movements or postures of bodies or body parts in the video clip or images, the system can determine that a particular body or body part belongs to the paying customer. Image-processing module 216 can further analyze images captured by the face camera to correlate a face in these images to the identified particular body or body part. More specifically, image-processing module 216 may select a face from multiple faces included in the captured face images based on one or more of: facial information from a full or partial face associated with the identified body, apparel information associated with the identified body, body posture or movement information associated with the identified body. For example, if the identified body is shown in the image captured by the body camera as being connected to a full or partial face, such a full or partial face can be used to match a face shown in an image captured by the face camera. Similarly, if the identified body is shown to be wearing an item of clothing in a particular color or pattern, and a face of a customer shown in the images captured by the face camera is wearing the same item of clothing, that face can be associated with the identified body. In addition to items of clothing, accessories (e.g., necklaces, earrings, headwear) can also be used to correlate a face to the identified body. Moreover, if the posture of the identified body suggests that the face shall have a particular position or orientation (e.g., a tilting angle with respect to the face camera), the system can identify a face that is positioned accordingly. In addition to posture, the position of the identified body can also assist the system in determining a face that correlates with the identified body making the payment movements. For example, if the system determines, based on images captured by the body camera, that a customer standing on the left side is making the payment, then the system can determine that a face that is on the left side in the image captured by the face camera is the face of the paying customer.

In some embodiments, videos and images from the cameras can be directly sent to image-processing module 216. More specifically, the body camera can continuously monitor and record the payment scene, and image-processing module 216 can analyze, in real time, the recorded video in order to determine that, at a particular time instant, a customer is performing the payment-initializing action (e.g., tapping an icon on the touchscreen display). Image-processing module 216 can then extract one or more images that record the customer's action, and can then record visual information included in the extracted images (e.g., the customer's facial or body information, apparel information, posture, or position) and the timing information associated with the customer's action. Image-processing module 216 can also process images captured by the face camera, and the system can recognize images that include one or more faces. Using the recorded timing information, the system can identify one or more face-containing images that are related to the payment action (e.g., images that are captured around the time when the payment action is performed). The system can then identify the face of the paying customer based on the visual information obtained from the body camera images. Alternatively, the body cameras may only be turned on after the customer enters the payment-initiating command. In other words, the customer's action can simultaneously trigger the face cameras and the body cameras, with the face camera configured to capture the face images and the body camera configured to capture the body images. The face images and the body images can be correlated based on their timestamps and can be sent to image-processing module 216 for processing. More specifically, the system can then analyze the body images to identify a body performing the payment movement and analyze the face images to match a face included in the face images to the identified body. The matched face belongs to the paying customer.

In addition to correlating a face with a body identified as the paying customer in order to identify a face belonging to the paying customer, the system may use additional criteria to select a face from multiple faces included in an image captured by the face camera. For example, the system may require that the paying customer faces substantially toward the face camera. A face that is tilted at an angle exceeding a threshold (e.g., 45° or 90°) can be excluded from consideration. Moreover, if a substantial portion (e.g., more than 20%) of a face is missing or blurry, the system can exclude such a face from consideration. If images captured by the face camera do not include a face that meets these requirements (e.g., the angle requirement and the clarity requirement), the system may cancel the current transaction and ask the paying customer to re-enter the command to initialize the payment process.

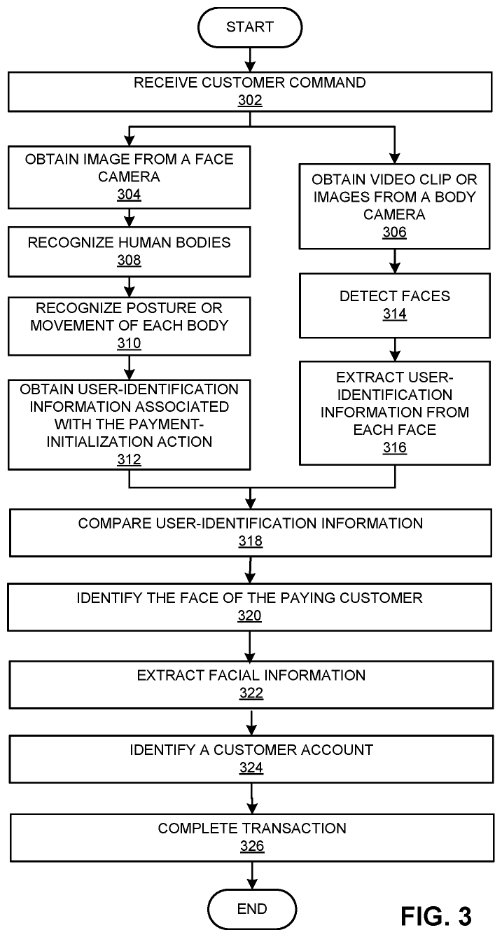

FIG. 3 presents a flowchart illustrating exemplary operations of the novel payment system having multiple viewing angles, according to one embodiment. During operation, the payment system receives a command from a customer to start the payment process (operation 302). More specifically, the payment system can include a terminal having a user interface, such as a touchscreen display, a pointing device (e.g., a mouse), or a keyboard. A customer making a payment for goods or services can enter a user command via the user interface.

In response to receiving the user command, the system can obtain one or more images from a face camera that is configured to capture face images (or close up shots of the face) of the customer (operation 304). In the meantime, the system can also obtain a video clip or one or more images from a body camera that is configured to capture body movements of the customer (operation 306). For example, the body camera can be configured to capture full shots of the payment scene or at least capture images of areas surrounding the user-input device, through which the customer is entering the payment-initialization command.

Obtaining such visual information (e.g., the video clip or images) from the body camera can involve obtaining the timing information associated with the paying customer's action for entering the command. In some embodiments, the body camera can continuously monitor and record the payment scene, and the timing information can be used to extract a video clip or one or more images from the video stream. In some embodiments, the body camera can continuously monitor and record the payment scene, and the system can also analyze, in real time, the recorded video in order to determine that at a particular time instant a customer is performing the payment-initialization action (e.g., tapping an icon on the touchscreen display). The system can then extract one or more images that record the customer's action. The system can also analyze images captured by the face camera, and can recognize images that include one or more faces. Using the recorded timing information, the system can identify one or more face-containing images that are related to the payment action (e.g., images that are captured around the time when the payment action is performed). Alternatively, the body camera may only be turned on subsequent to the user entering the payment-initialization command. In other words, the customer's action can simultaneously trigger the face camera and the body camera, with the face camera configured to capture the face images and the body camera configured to capture the body images.

The system recognizes one or more human bodies in the video clip or images obtained from the body camera (operation 308) and further recognizes the posture of or movements performed by each body (operation 310). For example, a human-body model (e.g., a kinetic model) can be trained beforehand and can be used to recognize human bodies and postures, and/or movements associated with the human bodies. More specifically, the system can recognize the body movement for initializing a payment process, such as extending an arm to tap an icon on the touchscreen display. In response to detecting that a body is performing such a movement, the system obtains user-identification information associated with the payment-initialization action based on the video clip or images from the body camera (operation 312). The user-identification information can include, but is not limited to: face (full or partial) or body information (e.g., apparel information, posture information, position information), or a combination thereof, associated with the detected body.

The system can simultaneously detect one or more faces from the images captured by the face camera (operation 314). Various face-detection techniques can be used to detect the faces. For each detected face, the system can extract user-identification information associated with the face from the images (operation 316). Because the face images often include additional body portions of the users, the user-identification information can also include, but is not limited to: face (full or partial) or body information (e.g., apparel information, posture information, position information), or a combination thereof, associated with the detected faces. The system can then compare the user-identification information associated with each face to the user-identification-information associated with the payment-initialization action to find a match (operation 318). A face having the matching user-identification information can be identified as the face of the paying customer (operation 320). If no match is found or if multiple matches are found due to the user-identification information being incomplete, the system can determine that the payment process fails and can request the customer to re-enter the payment-initialization command.

Once the face of the paying customer is identified, the system can extract facial information from the identified face (operation 322) and can identify a customer account based on the facial information (operation 324). The customer account can be a direct account with the payment system or a financial account (e.g., bank or credit card account) linked to the payment system. The payment system can then complete the transaction based on the identified customer account (operation 326). Note that, if no customer account can be identified (e.g., the customer does not have an account) or if the customer account does not have sufficient funds, the system can display an error to the customer, and may require the customer to render payment using a different payment method, such as paying with cash or paying with a credit card.

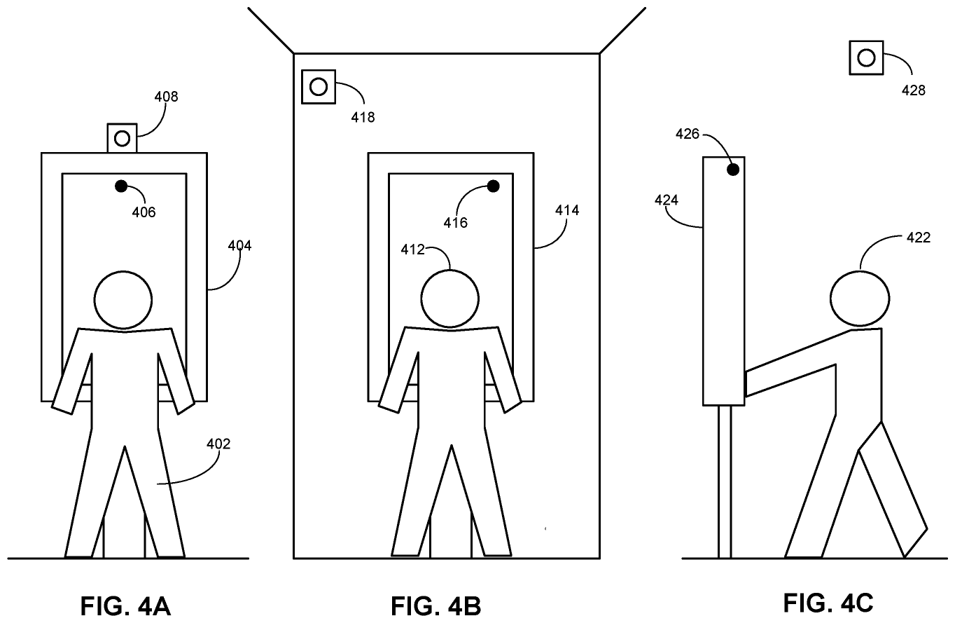

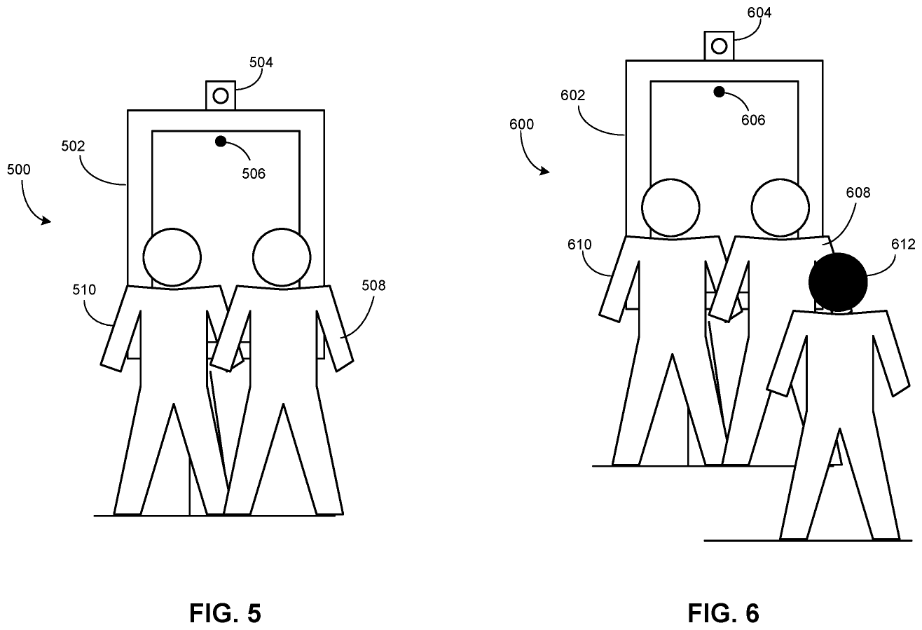

In addition to the camera arrangements shown in FIGS. 1A and 1B, there are other ways to arrange the at least two cameras. FIGS. 4A-4C show various camera placement schemes, according to one embodiment. In FIG. 4A, a customer 402 is standing in front of a payment terminal 404, facing the display of payment terminal 404. Payment terminal 404 can include cameras 406 and 408. More specifically, camera 406 is responsible for monitoring and/or recording the entire payment scene (e.g., by taking a full shot of the payment scene), and camera 408 is responsible for recording facial information of customer 402 (e.g., by taking a close up shot of the face of customer 402). In the example shown in FIG. 4A, camera 408 can be part of payment terminal 404 (e.g., can be placed at the upper edge of the display of payment terminal 404). More specifically, camera 408 can be placed at a location that is slightly above a person of average height. On the other hand, camera 406 can be situated atop payment terminal 404 and camera 408.

In FIG. 4B, a customer 412 is standing in front of a payment terminal 414, facing the display of payment terminal 414. Payment terminal 414 can include a camera 416 located at the right corner of its display. Camera 416 can be responsible for capturing face images of customer 412. A camera 418 can be placed near the ceiling (e.g., on the left side of payment terminal 414) to capture images of the payment scene that includes customer 412 and payment terminal 414.

FIG. 4C shows the side view of a customer 422 and a payment terminal 424. More specifically, FIG. 4C shows customer 422 reaching out to press a button on payment terminal 424. Payment terminal 424 can include a camera 426 positioned on the top edge of payment terminal 424. Camera 426 can be on either side or directly above customer 422. Camera 426 can capture close up face images of customer 422. A camera 428 can be placed at a position that is above and substantially away from payment terminal 424. For example, camera 428 can be attached to the ceiling or a tall post. Camera 428 can be placed to the right of payment terminal 424 and customer 422. Camera 428 can have a full view of the payment scene that includes customer 422 and payment terminal 424.

In addition to the scenarios shown in FIGS. 4A-4C, other camera arrangement schemes are also possible, as long as one camera can be arranged to have a full, unobstructed view of the entire payment scene (including the payment terminal and body movements of the customer or customers) and the other camera can have a clear view of the face of the paying customer. For example, a first camera can be placed on the ceiling, atop the payment terminal, or on a tall post such that it is substantially above the payment terminal; and a second camera can be placed at a position that is close to and slightly above the customer. The first camera can be on the left or right side of the payment terminal or customer, as long as it can have an unobstructed view of the customer's interactions with the terminal (e.g., the customer pressing a key or button on the payment terminal). The second camera can be installed on the payment terminal, as shown in FIGS. 4A-4C, or it can be installed on a separate device, as long as the customer is substantially facing the second camera when the customer is interacting with the payment terminal to initialize the payment process. The second camera can also be positioned on the left or right side of the customer.

FIG. 5 illustrates an exemplary operation scenario of the novel payment system, according to one embodiment. In FIG. 5, a payment system 500 includes a payment terminal 502, a first camera 504 positioned above payment terminal 502, and a second camera 506 positioned near an upper edge of the display of payment terminal 502. First camera 504 can continuously record the payment scene that includes customers 508 and 510 standing in front of payment terminal 502. One of the customers is paying for a service or goods, and to do so, he performs an action to initialize a paying-with-a-face payment process by entering a command on payment terminal 502. For example, the customer can tap a particular area (e.g., an icon) on the touchscreen display of payment terminal 502. Alternatively, the customer can press a key on a keyboard or a physical button associated with the payment terminal. The keyboard and the physical button can be located near the display of payment terminal 502. The display of payment terminal 502 can display user prompts, indicating to the customer how to initialize the paying-with-a-face payment process. A customer typically stands in front of payment terminal 502 to read the displayed user prompt and enter the payment-initialization command. Subsequent to payment system 500 receiving the payment-initialization command, second camera 506 can be triggered to capture one or more images that include both faces of customers 508 and 510. Moreover, a video clip or a sequence of images can be extracted from the video stream captured by first camera 504 based on the timing information associated with the customer's payment-initialization action.

Payment system 500 analyzes the video clip or sequence of images captured by first camera 504 and recognizes two bodies in the payment scene. The two bodies correspond to customers 508 and 510. Payment system 500 can further determine, based on postures of the bodies or movements of body parts, that one of the customers (e.g., customer 508) is the one performing the payment-initialization action (e.g., by extending his arm to touch a particular area on the screen of payment terminal 502). Accordingly, payment system 500 can extract various types of user-identification information associated with customer 508 from the video clip or images. The extracted user-identification information can include, but is not limited to: facial information (e.g., full or partial face), body posture information, position information, apparel information, accessory (e.g., jewelry or headwear) information, etc. System 500 further detects two faces (i.e., faces of customers 508 and 510) included in the image captured by camera 506. System 500 can then use the user-identification information extracted from the video clip or images captured by camera 504 to determine which face included in the image captured by camera 506 belongs to the identified body (i.e., the body of customer 508). For example, system 500 may also extract similar user-identification information from the images captured by camera 506 and compare such user-identification information with the user-identification obtained from the video clip or images captured by camera 504. If a match is found, system 500 can then determine that the face with the matching user-identification information belongs to the paying customer. System 500 can then extract facial information from that face and use the facial information to determine the identity of customer 508 and identify an account associated with customer 508. The account information can then be used by system 500 to complete the transaction. For example, system 500 can transfer appropriate funds from the identified account to the vendor's account. On the other hand, if no match is found, system 500 acknowledges that it has failed to recognize the paying customer and will display an error message on payment terminal 502 to prompt customer 508 to re-enter the command to start the payment process.

FIG. 6 illustrates an exemplary operation scenario of the novel payment system, according to one embodiment. In FIG. 6, a payment system 600 includes a payment terminal 602, a first camera 604 positioned above payment terminal 602, and a second camera 606 positioned near an upper edge of the display of payment terminal 602. Cameras 604 and 606 can be similar to cameras 504 and 506 shown in FIG. 5, respectively. In the scenario shown in FIG. 6, two customers 608 and 610 are standing in front of payment terminal 602, and a third customer 612 happens to stand behind customers 608 and 610. During operation, a customer (e.g., customer 608) initializes the paying-with-a-face payment process by entering a command on payment terminal 602. Similar to payment system 500, payment system 600 can obtain a video clip or images from camera 604 and images from camera 606 in response to receiving the command. Similarly, system 600 can recognize three bodies included in the video clip or images from camera 604, and can recognize that, among the three bodies, a particular body is performing the action of entering a command on payment terminal 602. For example, the posture of the particular body can be similar to the body posture of extending an arm to touch a particular area of the screen or press a physical key or button associated with payment terminal 602. Alternatively, the body posture can match a predefined body posture (e.g., a predefined hand signal or arm signal) that is associated with the paying-with-a face payment process. System 600 can also recognize three faces included in the images from camera 606 (e.g., faces of customers 608, 610, and 612). System 600 can then compare user-identification information associated with the body performing the payment action with user-identification information associated with the three faces. System 600 can determine that a particular face with the matching user-identification information is the face of the paying customer.

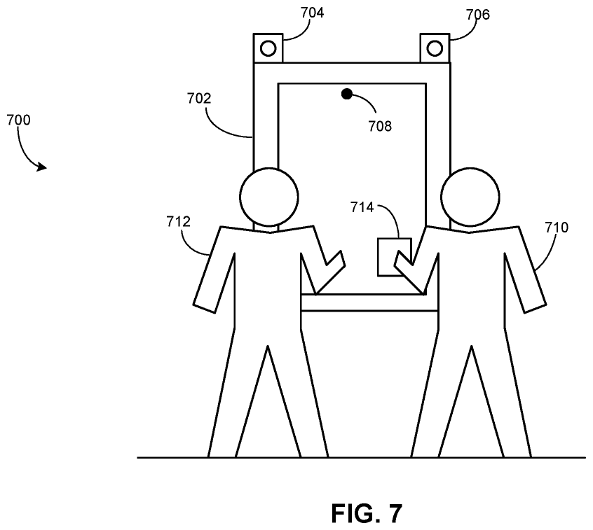

FIG. 7 illustrates an exemplary operation scenario of the novel payment system, according to one embodiment. In FIG. 7, a payment system 700 includes a payment terminal 702, a first camera 704 positioned above and on the left side of payment terminal 702, a second camera 706 positioned above and on the right side of payment terminal 702, and a third camera 708 positioned near an upper edge of the display of payment terminal 702. Cameras 704 and 706 can be similar to camera 504 shown in FIG. 5, and camera 708 can be similar to camera 506 shown in FIG. 5. More specifically, both cameras 704 and 706 can be responsible for monitoring the entire payment scene, but from different viewing angles, whereas camera 708 can be responsible for capturing images of the faces. In the example shown in FIG. 7, two customers 710 and 712 are standing in front of payment terminal 702. One of the customers (e.g., customer 710) attempts to make a payment for a service or goods by entering a payment-initialization command on terminal 702. More specifically, customer 710 extends his arm to tap an icon 714 on the touchscreen display of payment terminal 702. Roughly at the same time, the other customer, customer 712, may also extend his arm out toward the touchscreen of payment terminal 702. Both actions can be captured by cameras 704 and 706. Based on video clips and images captured by camera 704 or 706, system 700 can recognize both bodies and their extended arms. However, such information alone may not be enough to determine which body is indeed performing the action to initialize the payment process (i.e., which customer is the paying customer). In some embodiments, system 700 can combine images from both cameras 710 and 712 to extract 3D spatial information associated with the two bodies or two arms. Based on the spatial information, system 700 can determine the area on the touchscreen display each arm is extending toward and, hence, can determine which arm is performing the payment-initialization action based on the position of the particular icon the customer is required to tap in order to enter the payment command. Because two cameras at different locations are used to monitor body postures and positions, system 700 can obtain accurate 3D information of the payment scene, thus improving the accuracy in detecting the posture and movements of the body and/or body parts in images.

Note that, although using two cameras to monitor body movements can facilitate a more accurate detection of the true payment-initialization action in the event of multiple customers performing similar actions, it is also possible to use a single camera to perform such a task, as long as the single camera is strategically placed such that it can have a relatively high spatial awareness. In the example shown in FIG. 7, if a single camera is placed right in front of customers 710 and 712 (e.g., near an upper edge and at the center of the display of payment terminal 702), images or videos captured by the single camera can indicate to which areas the arms of customers 710 and 712 are extended. Accordingly, the system can determine which customer is, in fact, performing the payment-initialization action. Alternatively, if the single camera is placed on one side (e.g., the right side) of payment terminal 702, the system can also detect, based on images or videos captured by the single camera, the distance between a customer's arm and the camera. Based on the detected distance, the system can determine to which area on the touchscreen display the customer's arm is extended and further determine whether the customer is reaching for the payment-initialization icon or an irrelevant area.

In the aforementioned examples, the face camera captures still images (e.g., close up shots) of faces of customers in the payment scene, and facial information of the paying customer is extracted from the captured images. In practice, it is also possible for the face camera to capture a video of the faces of the customers. More particularly, in response to a customer entering the payment-initialization command, the face camera can start to record a video of a predetermined length (e.g., a few seconds). The system can then compare the video recorded by the face camera to the video recorded by the body camera to match a face to a body that is detected to be performing the payment-initialization action. Other variations can also be possible. For example, both cameras may only capture still images. In an extreme case, each camera may capture only one still image at the time instant when the customer is entering the payment-initialization command. Alternatively, each camera may capture a predetermined sequence of still images.

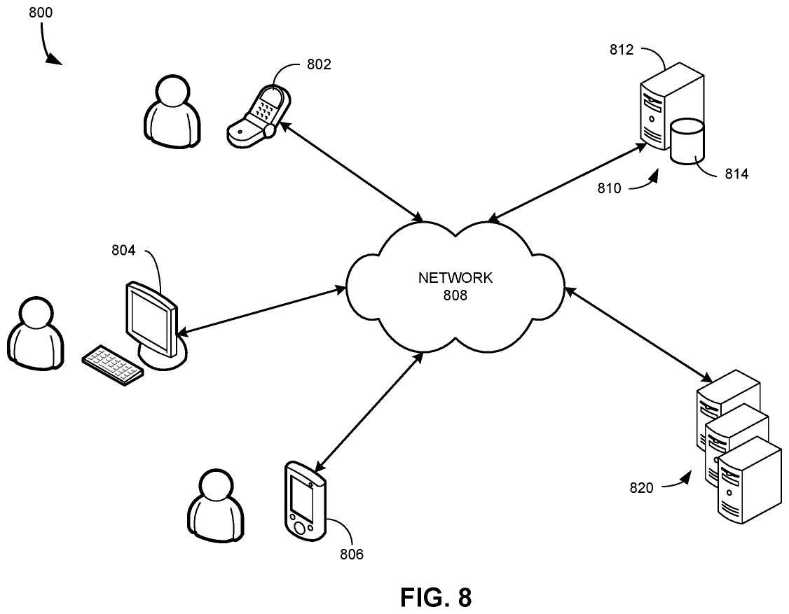

FIG. 8 illustrates an exemplary network environment for implementing the disclosed technology, in accordance with some embodiments described herein. A network environment 800 includes a number of electronic devices 802, 804 and 806 communicably connected to a server 810 by a network 808. One or more remote servers 820 are further coupled to the server 810 and/or the one or more electronic devices 802, 804 and 806.

In some exemplary embodiments, electronic devices 802, 804 and 806 can be computing devices, such as laptop or desktop computers, smartphones, PDAs, portable media players, tablet computers, televisions or other displays with one or more processors coupled thereto or embedded therein, or other appropriate computing devices that can be used for displaying a web page or web application. In one example, the electronic devices 802, 804 and 806 store a user agent such as a browser or application. In the example of FIG. 8, electronic device 802 is depicted as a smartphone, electronic device 804 is depicted as a desktop computer, and electronic device 806 is depicted as a PDA.

Server 810 includes a processing device 812 and a data store 814. Processing device 812 executes computer instructions stored in data store 814, for example, to assist in scheduling a customer-initiated service or a service-provider-initiated service between a service provider and a customer at electronic devices 802, 804 and 806 during a service scheduling process.

In some exemplary aspects, server 810 can be a single computing device such as a computer server. In other embodiments, server 810 can represent more than one computing device working together to perform the actions of a server computer (e.g., cloud computing). The server 810 may host the web server communicably coupled to the browser at the client device (e.g., electronic devices 802, 804 or 806) via network 808. In one example, the server 810 may host a client application for scheduling a customer-initiated service or a service-provider-initiated service between a service provider and a customer during a service scheduling process. Server 810 may further be in communication with one or more remote servers 820 either through the network 808 or through another network or communication means.

The one or more remote servers 820 may perform various functionalities and/or storage capabilities described herein with regard to server 810, either alone or in combination with server 810. Each of the one or more remote servers 820 may host various services. For example, servers 820 may host services providing information regarding one or more suggested locations such as web pages or websites associated with the suggested locations, services for determining the location of one or more users or establishments, search engines for identifying results for a user query, one or more user review or query services, or one or more other services providing information regarding one or more establishments, customers and/or reviews or feedback regarding the establishments.

Server 810 may further maintain or be in communication with social networking services hosted on one or more remote servers 820. The one or more social networking services may provide various services and may enable users to create a profile and associate themselves with other users at a remote social networking service. The server 810 and/or the one or more remote servers 820 may further facilitate the generation and maintenance of a social graph including the user-created associations. The social graphs may include, for example, a list of all users of the remote social networking service and their associations with other users of a remote social networking service.

Each of the one or more remote servers 820 can be a single computing device, such as a computer server, or can represent more than one computing device working together to perform the actions of a server computer (e.g., cloud computing). In one embodiment server 810 and one or more remote servers 820 may be implemented as a single server or a cluster of servers. In one example, server 810 and one or more remote servers 820 may communicate through the user agent at the client device (e.g., electronic devices 802, 804 or 806) via network 808.

Users may interact with the system hosted by server 810, and/or one or more services hosted by remote servers 820, through a client application installed at the electronic devices 802, 804, and 806. Alternatively, the user may interact with the system and the one or more social networking services through a web-based browser application at the electronic devices 802, 804, and 806. Communication among client devices 802, 804, 806 and the system, and/or one or more services, may be facilitated through a network (e.g., network 808).

Communication among the client devices 802, 804, 806, server 810 and/or one or more remote servers 820 may be facilitated through various communication protocols. In some aspects, client devices 802, 804, 806, server 810 and/or one or more remote servers 820 may communicate wirelessly through a communication interface (not shown), which may include digital signal processing circuitry where necessary. The communication interface may provide for communications under various modes or protocols, including Global System for Mobile communication (GSM) voice calls; Short Message Service (SMS), Enhanced Messaging Service (EMS), or Multimedia Messaging Service (MMS) messaging; Code Division Multiple Access (CDMA); Time Division Multiple Access (TDMA); Personal Digital Cellular (PDC); Wideband Code Division Multiple Access (WCDMA); CDMA2000; or General Packet Radio System (GPRS), among others. For example, the communication may occur through a radio-frequency transceiver (not shown). In addition, short-range communication may occur, including via the use of a Bluetooth-enabled device, Wi-Fi®, or another such transceiver.

Network 808 can include, for example, any one or more of a personal area network (PAN), a local area network (LAN), a campus area network (CAN), a metropolitan area network (MAN), a wide area network (WAN), a broadband network (BBN), the Internet, and the like. Further, network 808 can include, but is not limited to, any one or more of the following network topologies, including a bus network, a star network, a ring network, a mesh network, a star-bus network, a tree or hierarchical network, and the like.

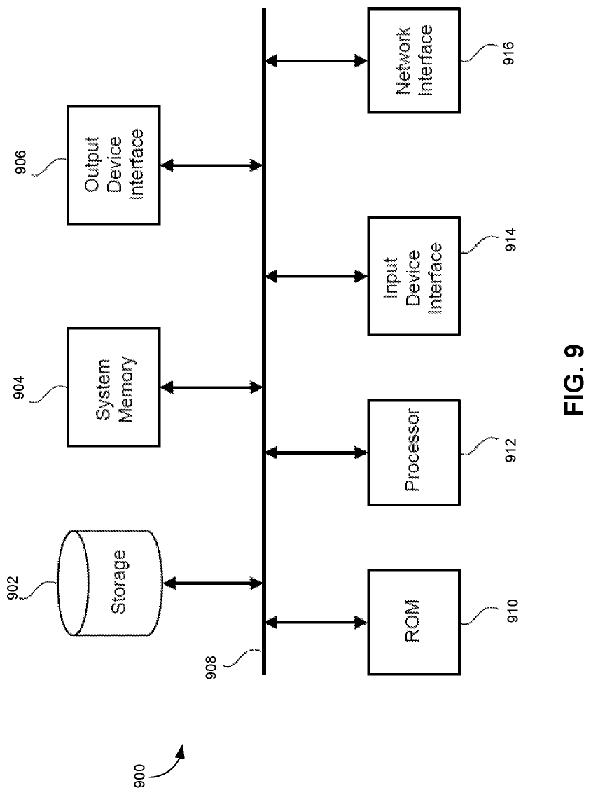

FIG. 9 conceptually illustrates an electronic system with which the subject technology is implemented, in accordance with some embodiments described herein. Electronic system 900 can be a client, a server, a computer, a smartphone, a PDA, a laptop, or a tablet computer with one or more processors embedded therein or coupled thereto, or any other sort of electronic device. Such an electronic system includes various types of computer-readable media and interfaces for various other types of computer-readable media. Electronic system 900 includes a bus 908, processing unit(s) 912, a system memory 904, a read-only memory (ROM) 910, a permanent storage device 902, an input device interface 914, an output device interface 906, and a network interface 916.

Bus 908 collectively represents all system, peripheral, and chipset buses that communicatively connect the numerous internal devices of electronic system 900. For instance, bus 908 communicatively connects processing unit(s) 912 with ROM 910, system memory 904, and permanent storage device 902.

From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of electronic system 900. Permanent storage device 902, on the other hand, is a read-and-write memory device. This device is a non-volatile memory unit that stores instructions and data even when electronic system 900 is off. Some implementations of the subject disclosure use a mass-storage device (such as a magnetic or optical disk and its corresponding disk drive) as permanent storage device 902.

Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such as a random access memory. System memory 904 stores some of the instructions and data that the processor needs at runtime. In some implementations, the processes of the subject disclosure are stored in system memory 904, permanent storage device 902, and/or ROM 910. From these various memory units, processing unit(s) 912 retrieves instructions to execute and data to process in order to execute the processes of some implementations.

Bus 908 also connects to input and output device interfaces 914 and 906, respectively. Input device interface 914 enables the user to communicate information and select commands to the electronic system. Input devices used with input device interface 914 include, for example, alphanumeric keyboards and pointing devices (also called “cursor control devices”). Output device interface 906 enables, for example, the display of images generated by electronic system 900. Output devices used with output device interface 906 include, for example, printers and display devices, such as cathode ray tubes (CRTs) or liquid crystal displays (LCDs). Some implementations include devices such as a touchscreen that function as both input and output devices.

Finally, as shown in FIG. 9, bus 908 also couples electronic system 900 to a network (not shown) through a network interface 916. In this manner, the computer can be a part of a network of computers (such as a local area network (“LAN”), a wide area network (“WAN”), an intranet, or a network of networks, such as the Internet. Any or all components of electronic system 900 can be used in conjunction with the subject disclosure.

These functions described above can be implemented in digital electronic circuitry; or in computer software, firmware or hardware. The techniques can be implemented using one or more computer program products. Programmable processors and computers can be included in or packaged as mobile devices. The processes and logic flows can be performed by one or more programmable processors or by one or more programmable logic circuitries. General and special purpose computing devices and storage devices can be interconnected through communication networks.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating processing a payment based on facial recognition, the method comprising:
obtaining, from a first camera, visual information associated with a payment scene which includes one or more customers;
in response to receiving a payment-initialization command, obtaining, from a second camera, an image comprising faces of the one or more customers;
identifying, based on the visual information associated with the payment scene, a body performing a movement while entering the payment-initialization command;
identifying a face in the image obtained from the second camera based on user-identification information associated with the identified body; and
extracting facial information from the identified face, thereby facilitating a transaction of the payment based on the extracted facial information.

2. The method of claim 1, wherein the visual information associated with the payment scene comprises a video or a still image.

3. The method of claim 1, wherein identifying the body performing the movement comprises:
receiving timing information associated with the payment-initialization command; and
analyzing the visual information based on the received timing information.

4. The method of claim 3, wherein analyzing the visual information comprises one or more of:
recognizing a posture of the body;
recognizing a movement of a portion of the body; and
recognizing a position of the body or the portion of the body.

5. The method of claim 1, wherein the user-identification information comprises one or more of:
body posture information;
position information;
partial facial information; and
apparel information.

6. The method of claim 1, wherein identifying the face comprises:
extracting, from each face included in the image, user-identification information associated with each face; and
comparing the user-identification information associated with each face to the user-identification information associated with the identified body.

7. The method of claim 6, further comprising:
in response to failing to find a match or finding multiple matches between the user-identification information associated with each face and the user-identification information associated with the identified body, displaying an error message.

8. The method of claim 1, further comprising:
identifying a customer based on the extracted facial information;
identifying an account corresponding to the identified customer; and
completing the transaction using the identified account.

9. The method of claim 1, wherein the payment-initialization command comprises one or more of:
a tapping on a touchscreen display;
a keystroke on a keyboard; and
a press of a physical button.

10. The method of claim 1, wherein a field of view (FOV) of the first camera is greater than a FOV of the second camera.

11. An apparatus for processing a payment based on facial recognition, comprising:
an input module configured to receive a payment-initialization command;
a first camera configured to obtain visual information associated with a payment scene which includes one or more customers;
a second camera configured to obtain an image comprising faces of the one or more customers, in response to the input module receiving the payment-initialization command;
a body-identification module configured to identify, based on the visual information associated with the payment scene, a body performing a movement while entering the payment-initialization command;
a face-identification module configured to identify a face in the image obtained by the second camera based on user-identification information associated with the identified body; and
a facial-information-extraction module configured to extract facial information from the identified face, thereby facilitating a transaction of the payment based on the extracted facial information.

12. The apparatus of claim 11, wherein the visual information associated with the payment scene comprises a video or a still image.

13. The apparatus of claim 11, wherein, while identifying the body performing the movement, the body-identification module is configured to:
receive timing information associated with the payment-initialization command; and
analyze the visual information based on the received timing information.

14. The apparatus of claim 13, wherein analyzing the visual information comprises one or more of:
recognizing a posture of the body;
recognizing a movement of a portion of the body; and
recognizing a position of the body or the portion of the body.

15. The apparatus of claim 11, wherein the user-identification information comprises one or more of:
body posture information;
position information;
partial facial information; and
apparel information.

16. The apparatus of claim 11, wherein, while identifying the face, the face-identification module is configured to:
extract, from each face included in the image, user-identification information associated with each face; and
compare the user-identification information associated with each face to the user-identification information associated with the identified body.

17. The apparatus of claim 16, further comprising a display configured to:
in response to the face-identification module failing to find a match or finding multiple matches between the user-identification information associated with each face and the user-identification information associated with the identified body, display an error message.

18. The apparatus of claim 11, further comprising:
a customer-identification module configured to identify a customer based on the extracted facial information;
an account-identification module configured to identify an account corresponding to the identified customer; and
a transaction module configured to complete the transaction using the identified account.

19. The apparatus of claim 11, wherein the payment-initialization command comprises one or more of:
a tapping on a touchscreen display;
a keystroke on a keyboard; and
a press of a physical button.

20. The apparatus of claim 11, wherein a field of view (FOV) of the first camera is greater than a FOV of the second camera.
